(19) United States
(12) Patent Application Publication
(10) Pub. No.: US 2024/0213693 A1
(43) Pub. Date: Jun. 27, 2024

(54) CONNECTION DEVICE AND METHOD FOR INSTALLING SUCH A CONNECTION DEVICE

(71) Applicant: Weidmüller Interface GmbH & Co. KG, Detmold (DE)

(72) Inventors: Andreas BRÖKER, Hövelhof (DE); Eugen KLONINGER, Schlangen (DE); Reinhard NOLTING, Detmold (DE); Jasper SCHREIBER, Lage (DE); Frank SIEKMANN, Paderborn (DE); Marco WALDHOFF, Steinheim (DE)

(21) Appl. No.: 18/557,515

(22) PCT Filed: Apr. 7, 2022
(86) PCT No.: PCT/EP2022/059300

§ 371 Date: Oct. 26, 2023

(30) Foreign Application Priority Data
Apr. 29, 2021 (DE) 10 2021 111 100.5

(51) Int. Cl. H01R 4/48

(52) U.S. Cl. CPC H01R 4/48185

(57) ABSTRACT

A connection device comprises at least one direct-plug-in clamping connection which has a direct-plug-in design for plugging in an electric conductor and which has a clamping spring, busbar and/or a clamping cage. The clamping spring is designed to clamp an electric conductor plugged into the direct-plug-in clamping connection to contact the busbar and/or the clamping cage in an electrically conductive manner. The direct-plug-in clamping connection additionally has an actuation mechanism which can be moved from a base position to an actuation position and back. In the actuation position, the actuation mechanism moves the clamping spring so as to release the electric conductor, wherein the actuation mechanism has at least two actuation regions which are provided for an actuation tool and which are arranged at an angle greater than 0 ° relative to each other. When the actuation mechanism is moved from the base position to the actuation position and returned back to the base position from the actuation position, it is moved about an imaginary rotational point which changes the position. A series connection assembly comprises at least two such connection devices designed in the form of series connection devices. A method is provided for installing such a connection device.

### BACKGROUND OF THE INVENTION

The invention relates to a connection device, a series connection assembly with two such connection devices and a method for installing such a connection device.

The direct-plug-in technique (also called the “push-in technique”) is regularly used in order to enable a fast, simple and secure connection of an electrical conductor to an electrical device, in particular an electrical connection device. In the process, the electrical conductor is introduced toollessly through a feed-in opening into an insulation material housing and is clamped there between a busbar and a clamping means, such as a clamping spring for example. Such connection devices often have an actuation means, with which the clamping spring can be moved, releasing the conductor from the insulation housing. The actuation means according to the prior art can alternatively be used in order to open the clamping spring to introduce a conductor.

EP 1 670 098 B1 discloses such a connection device, including an actuation means which is designed in an approximate L-shape and which can be actuated from two actuation directions oriented at an angle to one another to release the electrical conductor from the connection device. This configuration of the connection device enables actuation of the actuation means which satisfies most fitting situations, including in cases of cramped space conditions.

There is a need to produce a connection device which is further developed and which satisfies the even more cramped space conditions and the continual miniaturization of electrical devices and components.

### SUMMARY OF THE INVENTION

It is an object of the present invention to provide a connection device, a series connection assembly and a method of installing such a connection device.

A connection device includes at least one direct-plug-in clamping connection which has a push-in or direct-plug-in design for plugging in an electrical conductor. The direct-plug-in clamping connection has a clamping spring, which acts as a compression spring when connecting a conductor, and a busbar and/or a clamping cage, wherein the clamping spring is designed to clamp an electric conductor, which is plugged into the direct-plug-in clamping connection, so as to contact the busbar and/or the clamping cage in an electrically conductive manner. Furthermore, the direct-plug-in clamping connection has an actuation mechanism which can be moved from a base position to an actuation position, wherein this actuation mechanism, in the actuation position, moves the clamping spring, releasing the electrical conductor. The actuation mechanism has at least two actuation regions for placing an actuation tool in and which are arranged at an angle relative to one another that is greater than 0°. The angle is preferably arranged in a range between 0° and 140° and is preferably an approximate right angle or a precise right angle.

When the actuation mechanism is moved from the base position to the actuation position and returned back to the base position from the actuation position, it is moved, in particular pivoted, about an imaginary rotational point or a rotational axis which changes position in space.

The change of position of the imaginary rotational point around which the actuation mechanism rotates when moved enables a more compact configuration of the direct-plug-in clamping connection as compared to the prior art. As a result, the direct-plug-in clamping connection can be constructed to be smaller and more compact than others. In addition, this configuration of the direct-plug-in clamping connection makes it possible to place the actuation tool in actuation regions which are arranged in a larger angle range relative to one another.

It is preferred that the actuation mechanism is displaced along a guide when moved from the base position to the actuation position or back. As a result, controlled actuation of the actuation tool is possible. The guide can be arranged at a housing of the connection device (preferably insulated housing). In addition, the direct-plug-in clamping connection can be designed in a modular manner and have a clamping housing, which is formed in and/or on the guide.

It is preferred that the guide be designed in an arcuate shape. This design enables a smooth pushing movement when the actuation mechanism is actuated. In addition, the installation space required for the actuation mechanism is particularly small as a result. The guide is preferably designed to approximately correspond with the position of the changing imaginary rotational point. For this purpose, the guide is designed in the shape of a groove and the mating guide is designed in the shape of a bar or vice versa.

Furthermore, the actuation mechanism preferably has a mating guide designed corresponding to the profile of the guide. As a result, when the actuation mechanism is actuated, the mating guide is displaced along the guide, in a forcibly actuated manner. The profile of the guide and of the mating guide determine the change in position of the imaginary rotational point.

In a preferred embodiment, the actuation mechanism has an arcuate profile. Preferably, it is designed in an approximate sickle shape. In this embodiment, the guide can be arranged on an upper side of the actuation mechanism or be formed by the upper side of the actuation mechanism.

The actuation mechanism furthermore preferably has a clamping end which, when the clamping spring is actuated, rests against it and interacts with the clamping spring. The actuation mechanism preferably pushes the clamping spring from a clamping position, in which the clamping spring is provided to clamp the electrical conductor, against a restoring force of the clamping spring into a releasing position in which it releases the electrical conductor.

The actuation mechanism is preferably pushed back from the actuation position into the base position by the restoring force of the clamping spring. This is particularly preferred if the clamping spring pushes the mating guide, in the base position, against the guide. As a result, the actuation mechanism is clamped in the connection device.

A first actuation region, at which the actuation mechanism can be actuated by means of an actuation tool, is preferably arranged between an actuation end and a clamping end opposite the actuation end. A second such actuation region is arranged on the actuation end of the actuation mechanism. The actuation regions are preferably in each case externally accessible through an actuation aperture in the housing of the connection device. The actuation mechanism is arranged in an actuation space which is connected to the actuation apertures.

The actuation space is open towards the inner space of the connection device, in which the clamping spring as well as the clamping cage and/or the busbar are arranged. As a result, the clamping spring can be actuated by displacing the actuation mechanism. The actuation apertures are arranged at an angle to one another that is greater than 0°.

One of the actuation regions is preferably arranged at an upper side of the actuation mechanism, which in particular faces away from the clamping spring. Alternatively or in addition, an actuation region can also be arranged at an actuation mechanism inner side which faces the clamping spring, or at a transverse side which connects the outer side and the inner side.

In a preferred embodiment, the clamping spring is designed to be approximately v-shaped. It preferably has a retaining limb and a clamping limb. The retaining limb is fixed in the direct-plug-in clamping connection. The clamping limb extends into an inner space of the direct-plug-in clamping connection. It is preferably able to be moved in a releasing direction against a restoring force, such that the spring moves from the clamping position into the releasing position.

In the base position of the actuation mechanism, it is preferred that the clamping limb rests on the busbar and/or the clamping cage when an electrical conductor is not plugged in the direct-plug-in clamping connection. In contrast, when an electrical conductor is plugged in the direct-plug-in clamping connection, the clamping limb rests on the electrical conductor, clamping the electrical conductor between the clamping limb and the busbar and/or the clamping cage. By actuating the actuation mechanism, in particular with the actuation tool, the clamping limb is preferably moved in the release direction against the restoring force of the clamping spring. As a result, the electrical conductor which is plugged in the direct-plug-in clamping connection is released. It can then be removed from the direct-plug-in clamping connection.

Due to the restoring force of the clamping spring, releasing the actuation tool makes it possible for the clamping limb to return back automatically. The actuation mechanism is preferably also returned back from the actuation position into the base position.

In a further preferred embodiment, the connection device has a stop and the actuation mechanism has a counter stop, which interact and which are provided to secure the actuation mechanism in the actuation space. The stop and the counter-stop secure the actuation mechanism in the actuation space against falling/slipping out, in particular under the stress of vibrations.

The connection device can be provided to connect electrical conductors to one another or to electrical components, in particular electrical circuits.

In a preferred embodiment, the connection device is a series connection device which in particular can be latched onto a support rail. In this embodiment, the series connection device preferably has at least one, particularly preferably at least two, direct-plug-in clamping connections. Such a series connection device is preferably used in switch cabinet construction and/or in production devices.

It is further an object of the present invention to provide a series connection assembly with at least two such connection devices arranged alongside one another. The connection devices are preferably arranged alongside one another along a support rail.

It is further still an object of the present invention to provide a method for installing a connection device, in particular such a connection device in which first a clamping spring is installed in a housing of the connection device, and in which thereafter an actuation mechanism, which is provided to release an electrical conductor which is clamped in the connection device with the clamping spring, is installed by the actuation mechanism being inserted into the connection device through an actuation aperture. When the connection device is installed, it is provided in order to actuate the actuation mechanism. The clamping spring clamps the actuation mechanism after insertion in a base position in the connection device. Due to sufficient elasticity of the actuation mechanism and/or of the housing, the method can be carried out very quickly and simply. The clamping spring additionally ensures that the actuation element is brought into a position such that rear grips on the connection device and the actuation mechanism can take effect such that the actuation element cannot be lost.

The actuation mechanism, in the base position, preferably rests on a guide and/or a stop of the connection device.

### BRIEF DESCRIPTION OF THE FIGURES

The invention will be described below with the aid of figures. The figures are merely by way of example and do not restrict the general idea of the invention. In the drawings:

FIG. 1a is a side view of a connection device with two direct-plug-in clamping connections;

FIG. 1b is a partial sectional view of the connection device of FIG. 1a;

FIGS. 2a-2b are various side, front, top and perspective views of an actuation mechanism for the connection device of FIG. 1a;

FIGS. 3a-3b are side views of a direct-plug-in clamping connection of the connection device of FIG. 1a;

FIGS. 4a-4b are perspective views of the direct-plug-in clamping connection of the connection device of FIG. 1a when actuating the actuation mechanism from a first actuation direction;

FIGS. 5a-5d are perspective views of the direct-plug-in clamping connection of the connection device of FIG. 1a when actuating the actuation mechanism from a second actuation direction;

FIG. 6a is perspective view of a second embodiment of a connection device with two direct-plug-in clamping connections;

FIGS. 6b-6d are partial sectional views of the connection device of FIG. 6a during its installation;

FIGS. 6e-6f are partial sectional views of the connection device of FIG. 6a during insertion of an electrical conductor;

FIGS. 7a-7h are various side, front, top and perspective views of an actuation mechanism for the connection device of FIG. 6a; and

FIGS. 8a and 8b are partial perspective views of the connection device of FIG. 1a with the actuation mechanism of FIGS. 7a-7h during insertion of an electrical conductor.

### DETAILED DESCRIPTION

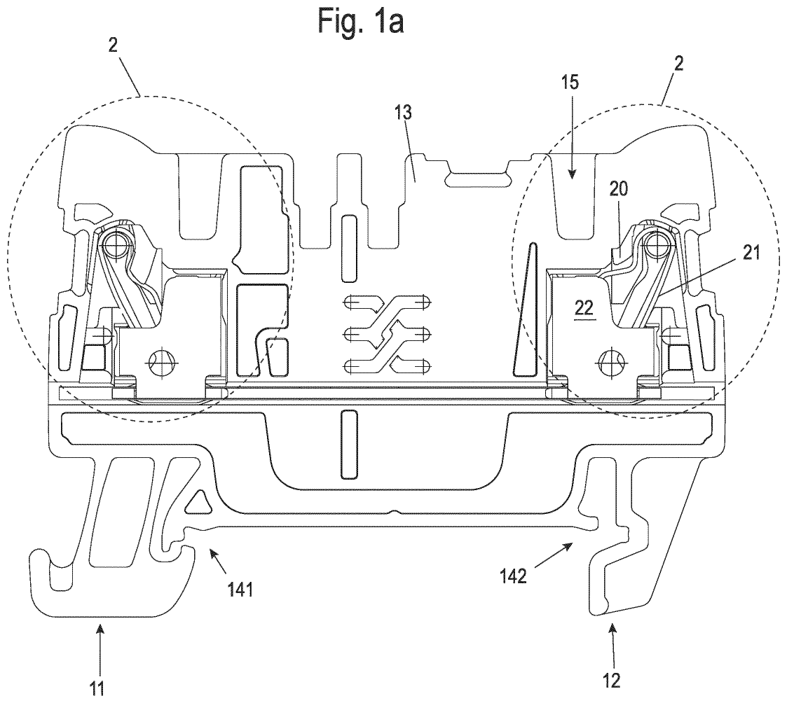

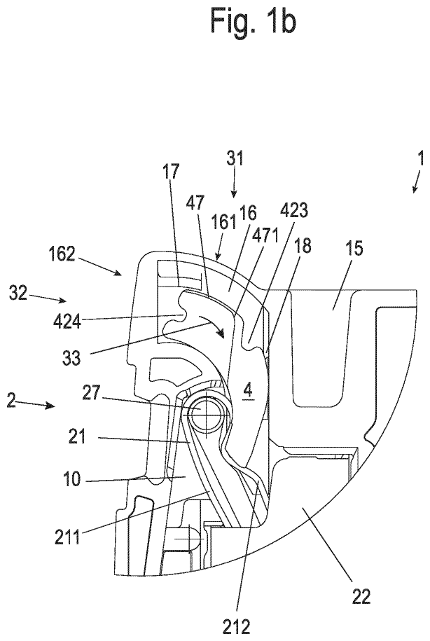

FIG. 1a shows a connection device 1 with two direct-plug-in clamping connections 2 in a side view and FIG. 1b is a cross-section from the connection device 1 from FIG. 1a. This is a series connection device which is provided for latching onto a, in particular hat-shaped, support rail (not shown). To latch onto the support rail, the connection device 1 can have, on opposite sides 11, 12, one latching mechanism 141, 142 respectively. Hereinafter, the terms connection device 1 and series connection device are used synonymously.

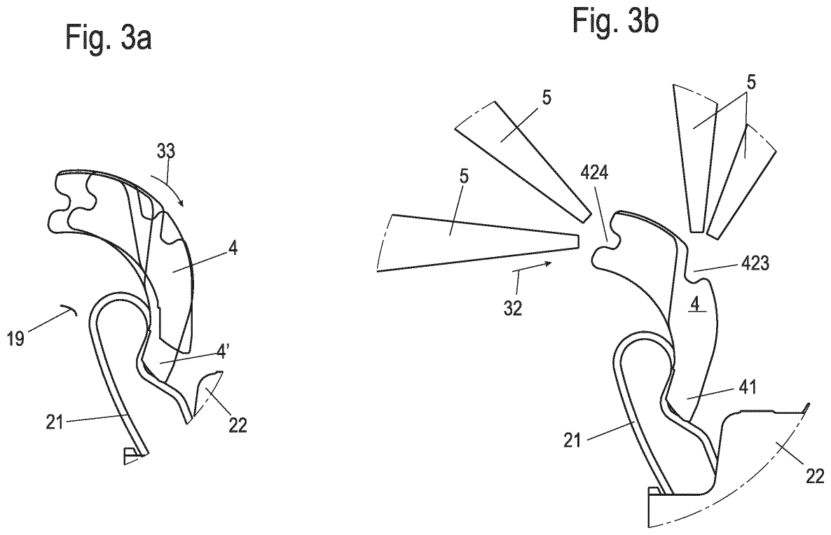

The one or more direct-plug-in clamping connections 2 have a push-in or direct-plug-in design for plugging-in an electrical conductor 6 (see FIGS. 3a and 3b). Furthermore, they are arranged in an insulation material housing 13 on the opposing sides 11, 12 of the connection device 1. They are oriented in a mirror-inverted manner relative to one another. They have in each case an inner space 10, in which there is arranged a clamping spring 21 and a clamping cage 22.

The respective clamping spring 21 is a generally v-shape design and in this embodiment of the connecting clamp 1 is vertically oriented. When contacting conductors, it acts as a compression spring. It has a retaining limb 211 and a clamping limb 212 and is laid around a clamping bar 27. The retaining limb 211 is fixed in the direct-plug-in clamping connection 2, and the clamping limb 212 extends into the clamping cage 22. The clamping limb 212 can be pivoted from a clamping position K into a releasing position L against a restoring force of the clamping spring 21 in a releasing direction (not shown) about a clamping axis (not shown), along which the clamping bar 27 extends. Here, a clamping angle (not shown) between the retaining limb 211 and the clamping limb 212 is reduced. The restoring force of the clamping spring 21 causes pivoting back from the releasing position L, against the releasing direction, to the clamping position K.

The clamping cage 22 is designed to be electrically conductive. It is used here as a busbar and is arranged on a busbar which connects the clamping cages 22.

Alternatively or in addition, a busbar (not shown) can extend in the clamping cage 22 and/or in the inner space 10. The busbar is then arranged such that the clamping spring 21, in the clamping position K, clamps between the clamping spring 21 and the busbar an electrical conductor 6 which has been introduced into the connecting clamp 1. The electrical conductor 6 contacts the bus bar and/or the clamping cage 22 in an electrically conductive manner.

One conductor insertion aperture 15, through which an electrical conductor 6 can be introduced to the direct-plug-in clamping connection 2, is allocated to each of the one or more direct-plug-in clamping connections 2 respectively.

FIG. 1b shows a cross-section from the respective connection device 1 from FIG. 1a. Hereinafter, the connection device 1 will be described using a single direct-plug-in clamping connection 2. The description relates analogously to additional direct-plug-in clamping connections 2 of the connection device 1.

The respective direct-plug-in clamping connection 2 has an actuation mechanism 4 which can be moved from a base position G to an actuation position B, and is envisaged to be movable. It is shown in the actuation position B in which it pushes the clamping spring 21 into the releasing position L, releasing a plugged-in electrical conductor 6. For this purpose, the clamping limb 212 of the clamping spring 21, in the actuation position B, is pushed in the release direction with the actuation mechanism 4.

When moved from the base position G to the actuation position B or back, the actuation mechanism 4 is displaced along a guide 17 in an actuation direction 33. As a result, it is possible to control actuation of an actuation tool 5 used for the actuation of the actuation mechanism 4. The guide 17 is arranged at the housing 13 of the connection device 1. The actuation mechanism 4 has a mating guide 47 which is forcibly guided at least partially along the guide 17 when the actuation mechanism 4 is displaced. The actuation mechanism 4 and its guide 47 have an arcuate configuration. As a result, the installation space required for actuation of the actuation mechanism 4 is particularly small. The guide 17 and the mating guide can also take on a securing function against falling out of the housing.

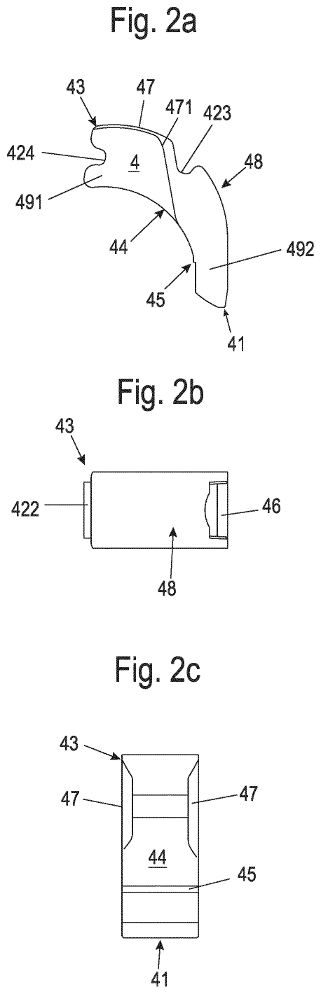

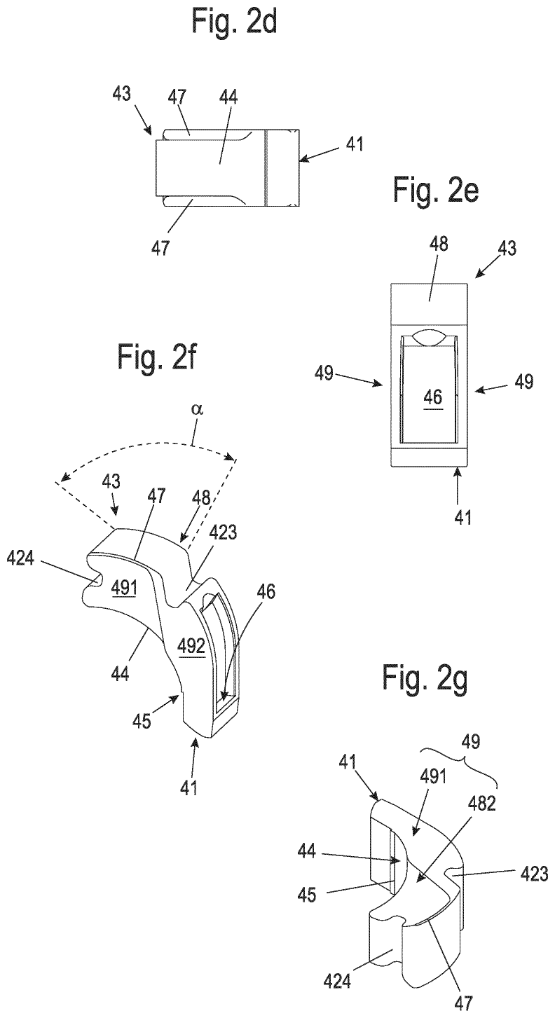

Furthermore, the connection device 1 can also have a stop 18 and the actuation mechanism 4 have a counter stop 46 (see FIGS. 2a-2g). These interact and are provided to secure the actuation mechanism 4 in an actuation space 16 in the connection device 1.

The stop 18 and the respective counter-stop 46 provided in a connecting link secure the actuation mechanism 4 against falling out of the housing 13, in particular under the stress of vibration. The stop 18 in FIG. 1b is a bar which serves as a counter-stop when the actuation mechanism rotates out.

To actuate the actuation mechanism 4, two actuation regions 423, 424 are provided for an actuation tool 5. The actuation regions 423, 424 are arranged at an angle α greater than 0° relative to one another, in this case at an approximate right angle.

The actuation space 16, in which the actuation mechanism 4 is arranged, and the inner space 10, in which the direct-plug-in clamping connection 2 is arranged, are connected to one another. As a result, the clamping spring 21 can be actuated with the actuation mechanism 4.

The first actuation region 423, which is arranged on the actuation mechanism 4, is externally accessible through a first actuation aperture 161 in the housing 13. The second actuation region 424 is externally accessible through a second actuation aperture 162 in the housing 13. The actuation tool 5 can be used in a first actuation direction 31, through the first actuation aperture 161, to actuate the actuation mechanism 4, and can be used in a second actuation direction 32, through the second actuation aperture 162, to actuate the actuation mechanism 4. For this purpose, the actuation apertures 161, 162 are arranged at approximately the same angle as the actuation regions 423, 424 are arranged relative to one another.

FIGS. 2a-2g show the actuation mechanism 4 for the connection device 1 of FIG. 1a in various side and perspective views.

The actuation mechanism 4 is designed to be approximately sickle-shaped having an actuation end 43 and a clamping end 41, with the clamping end 41 being provided to actuate the clamping spring 21.

The first actuation region 423 is arranged between the actuation end 43 and the clamping end 41, with the second actuation region 424 being arranged at the actuation end 43 of the actuation mechanism 4. The actuation regions 423, 424 are formed here by indentations into which a screwdriver can be placed as an actuation tool 5. The first actuation region 423 is arranged on an upper side 48 of the actuation mechanism 4. In this embodiment of the connection device 1 from FIG. 1a in its installed state, the upper side 48 is arranged on a side of the actuation mechanism 4 which faces away from the clamping spring 21.

Optionally, a bar-shaped protrusion 45 can be arranged on an underside 44 which is opposite the upper side 48. When the clamping spring 21 is actuated, this protrusion can interact with the clamping spring 21.

The transverse sides 49 connecting the upper side 48 and the underside 44 each have a narrow wall region 491 and a wide wall region 492. The narrow wall region 491 is provided in the region of the mating guide 47. The mating guide 47 ends at the wide wall region 492. When the actuation mechanism 4 is displaced, the mating guide 47 is pushed against the guide 17 of the connection device 1 with the clamping spring 21. When there is displacement counter to the actuation direction 33, the end 471 of the mating guide 47, comes to bear on the guide 17 such that the actuation mechanism 4 cannot be further displaced counter to the actuation direction 33.

Furthermore, the counter-stop 46 is provided on the upper side 48. Here, it is formed by a rectangular depression, with the stop 18 of the connection device 1 interacting with an edge of the depression respectively at an upper and at a lower end of the depression. As a result, the actuation mechanism 4 is not displaced further in or counter to the actuation direction 33.

FIGS. 3a and 3b show a cross-section from the direct-plug-in clamping connection 2 of the connection device 1 of FIG. 1a. The displacement of the actuation mechanism 4 from the base position G to the actuation mechanism 4′ in the actuation position B is shown.

When the actuation mechanism 4 is displaced from the base position G to the actuation position B and returned back to the base position G from the actuation position B, the actuation mechanism 4 is displaced about an imaginary rotational point or a rotational axis 19 which changes positions. This is schematically depicted in FIG. 3a.

The change of position of the imaginary rotational point 19 around which the actuation mechanism 4 rotates when displaced, enables a very compact design of the direct-plug-in clamping connection 2 and connecting device 1.

For this purpose, the guide 17 and the mating guide 47 are designed to correspond with the position of the changing rotational point 19. Here, the guide 17 has a groove configuration and the mating guide 47 has a bar configuration.

FIG. 3b schematically shows actuation of the actuation mechanism 4 from various angles with an actuation tool 5.

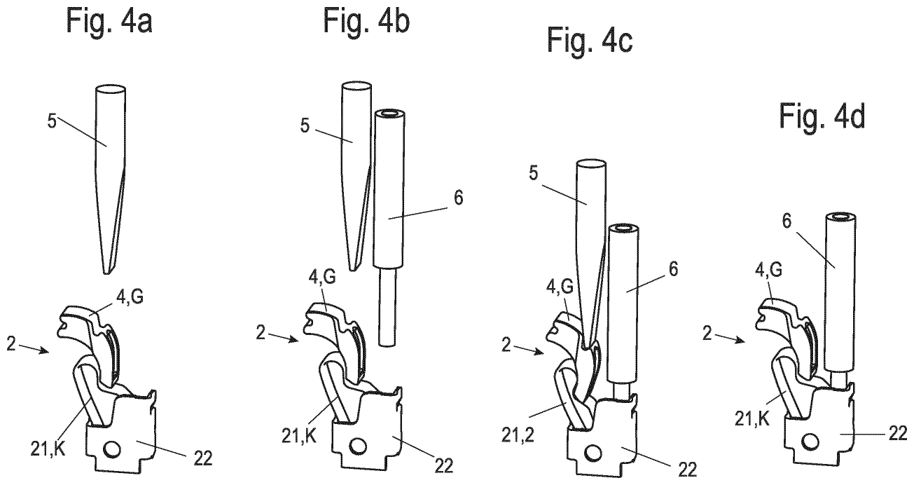

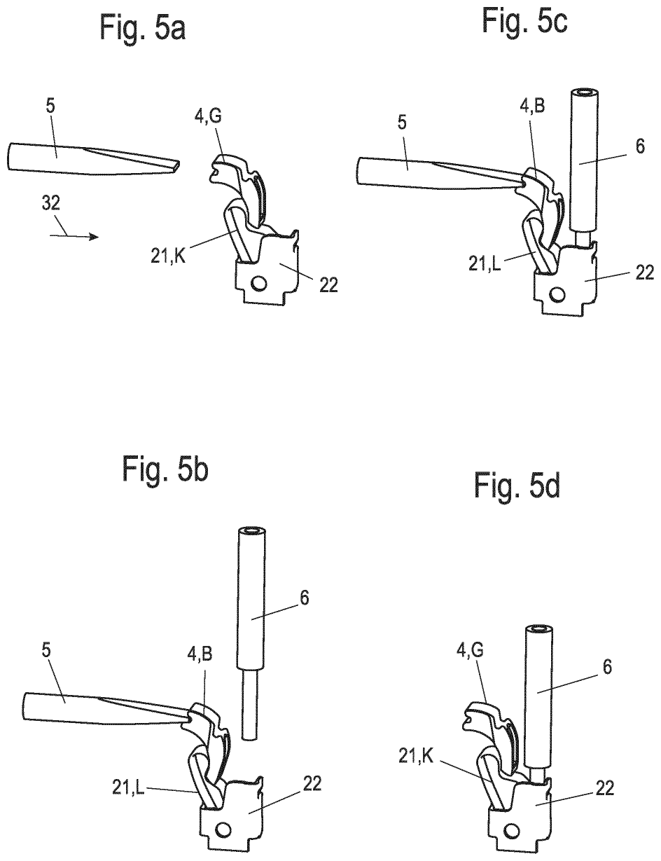

FIGS. 4a-4d show a cross-section from the direct-plug-in clamping connection 2 of the connection device 1 of FIG. 1a when actuating the actuation mechanism 4 from a first, above actuation direction 31. FIGS. 5a-5d show a cross-section from the direct-plug-in clamping connection 2 of the connection device 1 of FIG. 1a when actuating the actuation mechanism 4 from a second, side actuation direction 32. The actuation directions 31, 32 are arranged at an approximate right angle.

FIG. 4a shows the actuation mechanism 4 in the base position G, wherein the clamping spring 21 is arranged in the clamping position K. There is still no electrical conductor 6 introduced into the direct-plug-in clamping connection 2.

FIG. 4b shows the actuation mechanism 4 in the base position G, wherein the clamping spring 21 is arranged in the clamping position K and wherein an electrical conductor 6 is meant to be introduced into the direct-plug-in clamping connection 2.

FIG. 4c shows the actuation mechanism 4 in the actuation position B, wherein the clamping spring 21 is arranged in the releasing position L. The electrical conductor 6 is introduced into the direct-plug-in clamping connection 2, but is not yet clamped.

FIG. 4d shows the actuation mechanism 4 in the base position G, wherein the clamping spring 21 is arranged in the clamping position K. The electrical conductor 6 is clamped in the direct-plug-in clamping connection 2.

FIG. 5a shows the actuation mechanism 4 in the base position G, wherein the clamping spring 21 is arranged in the clamping position K. There is still no electrical conductor 6 introduced into the direct-plug-in clamping connection 2.

FIG. 5b shows the actuation mechanism 4 in the actuation position B, wherein the clamping spring 21 is arranged in the releasing position L and wherein an electrical conductor 6 is introduced into the direct-plug-in clamping connection 2.

FIG. 5c shows the actuation mechanism 4 in the actuation position B, wherein the clamping spring 21 is arranged in the releasing position L. The electrical conductor 6 is introduced into the direct-plug-in clamping connection 2, but is not yet clamped.

FIG. 5d shows the actuation mechanism 4 in the base position G, wherein the clamping spring 21 is arranged in the clamping position K. The electrical conductor 6 is clamped in the direct-plug-in clamping connection 2.

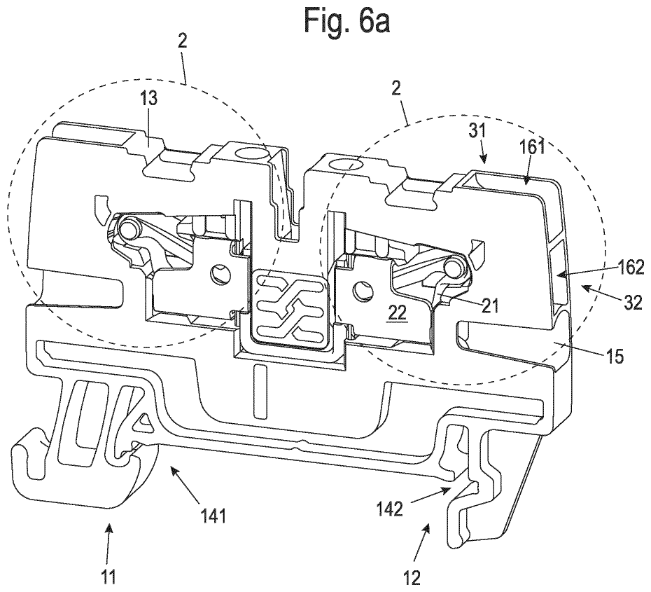

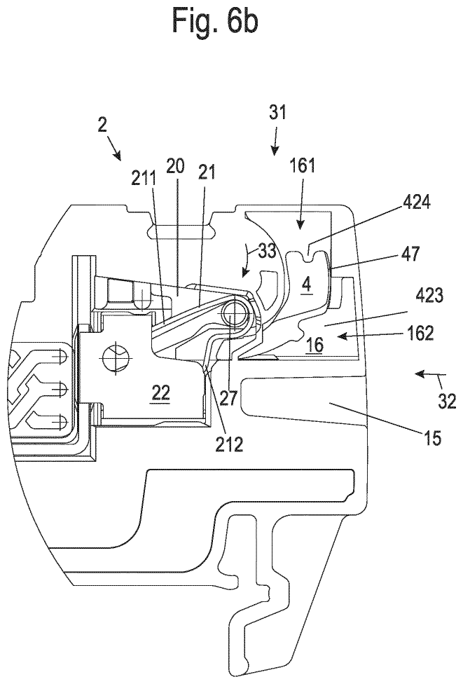

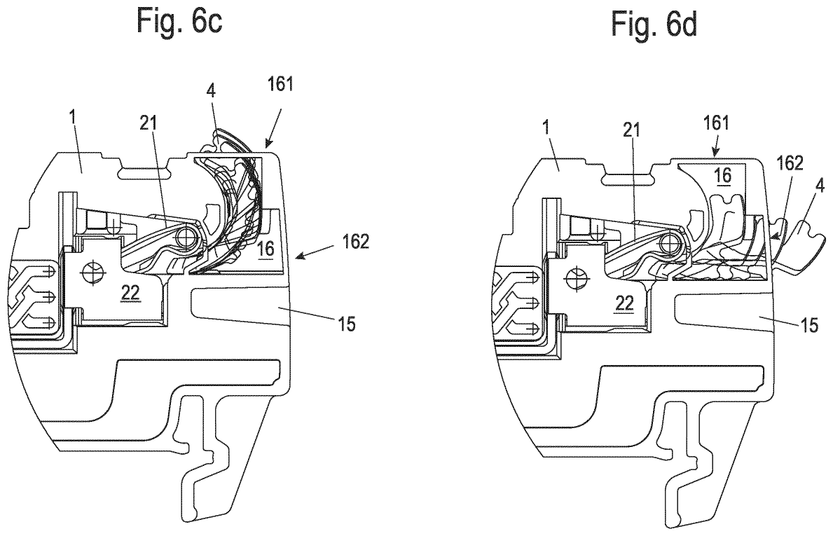

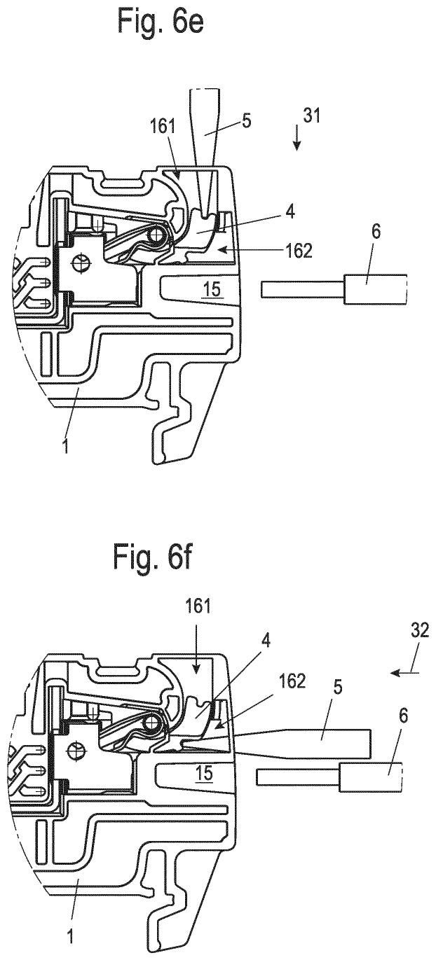

FIG. 6a is a perspective view of a second embodiment of a connection device 1 with two direct-plug-in clamping connections 2. FIG. 6b is a cross-section from the connection device 1 in FIG. 6a. This connection device 1 is also a series connection device.

In this embodiment of the connection device 1, the clamping spring 21 is horizontally arranged. As a result, the second actuation region 424, which is arranged at the actuation end 43 is accessible from above through the first actuation aperture 161. The first actuation region 423, which is arranged between the clamping end 41 and the actuation end 43, is accessible from the side through the second actuation aperture 162 (see FIG. 6b).

FIGS. 6c-6d show the connection device 1 during its installation.

Introduction of the actuation mechanism 4 through the first actuation aperture 161 is shown in FIG. 6c, and introduction of the actuation mechanism 4 through the second actuation aperture 162 is visible in FIG. 6d.

During installation, the clamping spring 21 is first fitted into the housing 13 of the connection device 1. Thereafter, the actuation mechanism 4 inserted through one of the actuation apertures 161, 162 into the actuation space 16.

After insertion, the clamping spring 21 clamps the actuation mechanism 4 in the base position G. The actuation mechanism 4 then rests with its mating guide 47 on the guide 17 of the connection device 1 and is clamped in it.

FIGS. 6e-6f show the electrical conductor 6 introduced into one of the direct-plug-in clamping connections 2. The actuation of the actuation mechanism 4 through the first actuation aperture 161 during plugging-in of the electrical conductor 6 through the conductor insertion aperture 15 is depicted in FIG. 6e, and the actuation of the actuation mechanism 4 through the second actuation aperture 162 during plugging-in of the electrical conductor 6 through the conductor insertion aperture 15 is depicted in FIG. 6f.

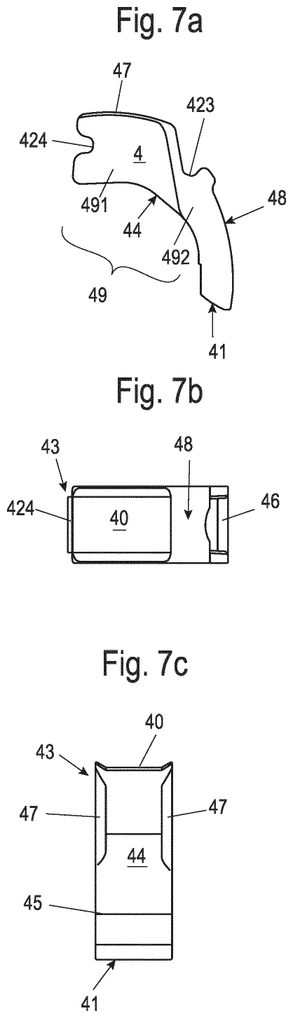

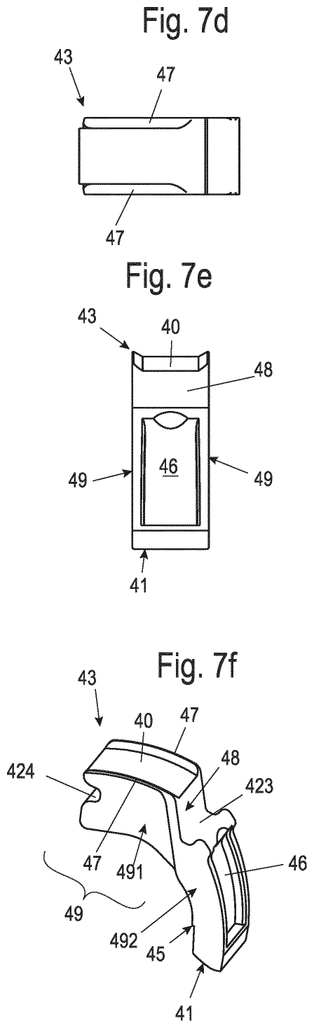

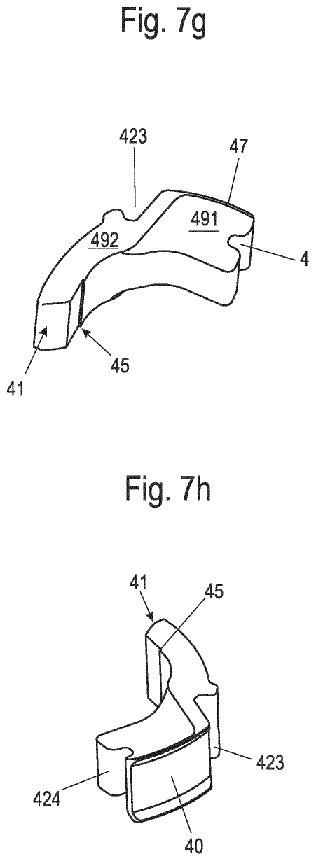

FIGS. 7a-7h show the actuation mechanism 4 for the connection device 1 of FIG. 6a. The actuation mechanism 4 of FIG. 7 differs from the actuation mechanism 4 of FIG. 2 mainly through a recess 40 on the upper side 48 of the actuation mechanism 4. Guide bars 131 are arranged on the housing 13 of the connection device 1 and engage in the recess 40. In this embodiment, guiding the actuation mechanism 4 is further improved and these profiles can be selected such that they act as a dovetail guide so that the walls in the arranging direction are ideally pulled together rather than pushed apart.

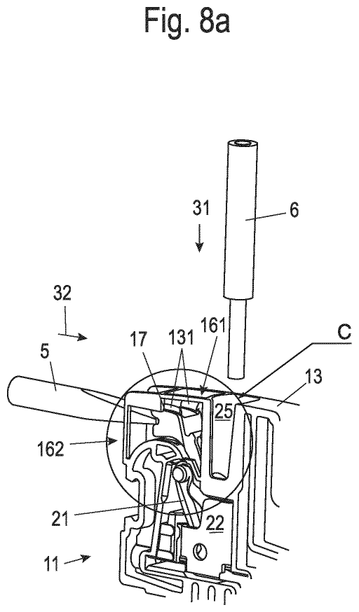

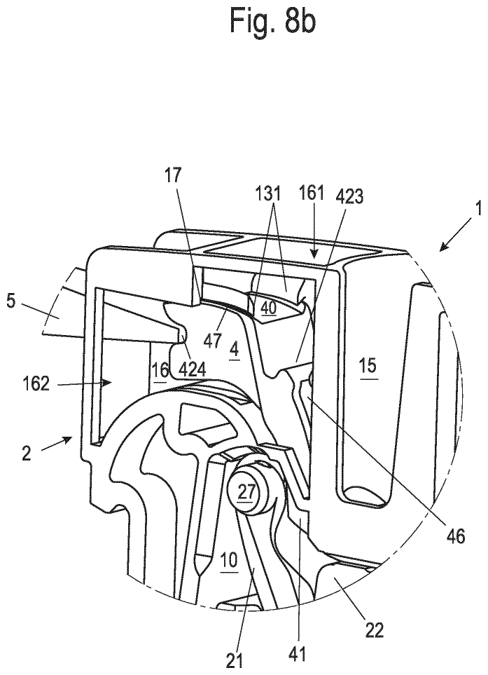

FIGS. 8a-8b show the connection device 1 of FIG. 1 with the actuation mechanism 4 of FIG. 7a, with FIG. 8a showing a cross-section of the connection device 1 during insertion of an electrical conductor 6, and FIG. 8b showing an enlarged cross-section from FIG. 8a.

17. A connection device comprising at least one direct-plug-in clamping connection having a direct-plug-in design for plugging in an electrical conductor, the at least one direct-plug-in clamping connection having at least one of a clamping spring, a busbar and a clamping cage, wherein the clamping spring is designed to clamp an electrical conductor plugged into the direct-plug-in clamping connection to form an electrically conductive contact with the busbar or the clamping cage, the at least one direct-plug-in clamping connection further having an actuation mechanism movable between a base position and an actuation position for moving the clamping spring to release the electrical conductor, the actuation mechanism having at least two actuation regions for an actuation tool, the at least two actuation regions arranged at an angle (α)>0 relative to each other,
wherein
the actuation mechanism is moved about an imaginary rotational point when moved between the base position and the actuation position, the imaginary rotational point having a position that changes as the actuation mechanism is moved.

18. The connection device according to claim 17, wherein the actuation mechanism is displaced along a guide when moved between the base position and the actuation position.

19. The connection device according to claim 18, wherein the guide has an arcuate shape generally corresponding to the position of the changing rotational point.

20. The connection device according to claim 18, wherein the actuation mechanism has a mating guide having a design that corresponds to the profile of the guide.

21. The connection device according to claim 20, wherein the guide and first mating guide include a groove and bar, respectively, or the guide and first mating guide include a bar and groove, respectively.

22. The connection device according to claim 18, wherein the actuation mechanism has an arcuate profile being generally sickle shaped.

23. The connection device according to claim 17, wherein the actuation mechanisms further has a clamping end which when actuated rests against and pushes the clamping spring into a releasing position from a clamping position against a restoring force of the clamping spring.

24. The connection device according to claim 23, wherein the actuation mechanism is pushed back into the base position from the actuation position by the restoring force of the clamping spring, wherein the clamping spring pushes the mating guide against the guide in the base position.

25. The connection device according to claim 17, wherein the first actuation region is arranged between an actuation end and a clamping end opposite the actuation end and the second actuation region is arranged at the actuation end of the actuation mechanism.

26. The connection device according to claim 17, wherein the actuation mechanism is arranged in an actuation space externally accessible through first and second actuation apertures, the first actuation region being accessible through the first actuation aperture and the second actuation region being accessible through the second actuation aperture.

27. The connection device according to claim 17, wherein one of the actuation regions is arranged on an upper side of the actuation mechanism.

28. The connection device according to claim 17, wherein the direct-plug-in clamping connection has a stop and the actuation mechanism has a counter stop arranged to interact with the stop, the stop and counter stop being provided to secure the actuation mechanism in the actuation space.

29. The connection device according to claim 17, wherein the connection device is a series connection device having at least one direct-plug-in clamping connection.

30. A series connection assembly with at least two connection devices according to claim 1 being arranged alongside one another along a support rail.

31. A method of installing a connection device according to claim 1 comprising the steps of, installing a clamping spring in a housing and installing an actuation mechanism for releasing an electrical conductor clamped in the connection device with the clamping spring by inserting it into the connection device through an actuation aperture, wherein the actuation mechanism is actuated via the actuation aperture when the connection device is installed and the clamping spring clamps the actuation mechanism in the connection device when inserted in a base position.

32.The method according to claim 31, wherein when the actuation mechanism is installed and in the base position the actuation mechanism rests on a guide or a stop of the connection device.
